(19) United States
(12) Patent Application Publication
(10) Pub. No.: US 2022/0139075 A1
(43) Pub. Date: May 5, 2022

(54) DEEP LEARNING GUIDE DEVICE AND METHOD

(71) Applicant: ORIENTAL MIND (WUHAN) COMPUTING TECHNOLOGY CO., LTD., Wuhan (CN)

(72) Inventors: DONGMING XIE, Wuhan (CN); Qiuchen YI, Wuhan (CN); Jian LIN, Wuhan (CN)

(21) Appl. No.: 17/577,330

(22) Filed: Jan. 17, 2022

Related U.S. Application Data
(63) Continuation of application No. PCT/CN2020/118924, filed on Sep. 29, 2020.

(30) Foreign Application Priority Data
Jul. 14, 2020 (CN) 2020106754671

(51) Int. Cl. G06V 10/94; G06V 10/776; G06V 10/774

(52) U.S. Cl. CPC G06V 10/945; G06V 10/774; G06V 10/776

(57) ABSTRACT

The present invention discloses a deep learning guide device and method. The device at least includes a graphical operation interface component configured for receiving data set, determining a storage address of the data set, and receiving a data annotation operation of a user; and further includes a background logic processing component configured for obtaining data annotation information according to the data annotation operation and storing to a preset storage area, generating a training model and a deep learning result evaluation report based on the data set and the data annotation information and storing to the preset storage area.

### CROSS-REFERENCE TO RELATED APPLICATIONS

The present application claims the benefit of International Application No. PCT/CN2020/118924, entitled “Deep Learning Guide Device And Method” filed on 2020 Sep. 29, which claims foreign priorities of Chinese Patent Application No. 202010675467.1, filed on 2020 Jul. 14, the entirety of which is hereby incorporated by reference in its entirety.

### TECHNICAL FIELD

The present disclosure relates to a technical field of computer technology, and particularly to a deep learning guide device and method.

### BACKGROUND

Deep learning (DL) is a new research direction in the field of machine learning (ML), which is introduced into the machine learning to make it more close to the original goal—Artificial Intelligence (AI). Deep learning learns the internal laws and representation levels of sample data. The information obtained in the learning process is of great help to the interpretation of data such as text, images and sounds. Its ultimate goal is to enable machines to have the ability to analyze and learn like humans, and to recognize data such as text, images, and sounds. Deep learning is a complex machine learning algorithm, effects achieved in speech and image recognition far surpassed previous related technologies. Deep learning has achieved many results in search technology, data mining, machine learning, machine translation, natural language processing, multimedia learning, speech, recommendation and personalization technology, and other related fields. Deep learning enables machines to imitate human activities such as audio-visual and thinking, and solves many complex pattern recognition problems, which has made great progress in artificial intelligence-related technologies.

### Technical Problem

In recent years, deep learning technology has developed rapidly and has been widely applied in many industries. As more and more deep learning projects are produced, we find that more and more problems and challenges emerge. Specifically, these problems include:

The whole life cycle of artificial intelligence jobs is too complex. A complete artificial intelligence job from preparation to implementation to application, usually includes data collection, data upload, data annotation, algorithm coding, model training, hyper parameter tuning, model evaluation, model deployment, model trial, data inference, etc. The work in different stages also involves different tools and different personnel requirements. This makes a traditional artificial intelligence project usually require multiple cooperation of multiple work types to complete, which greatly lengthens the development cycle and increases development costs. The application of artificial intelligence technology requires too much professionalism. In the process of traditional artificial intelligence technology application, the algorithm requires professionals to be coded, and tested and tuned many times to produce a high quality model. This requires both professional programming skills and in-depth to understand the principle of the algorithm, it also need to have the knowledge background in the business field, which puts forward higher requirements for the professionalism of the project personnel involved in artificial intelligence needs, which makes it impossible for ordinary business personnel to quickly and conveniently develop their own business based on artificial intelligence.

### SUMMARY

A deep learning guide device is provided by the present application. The deep learning guide device at least includes a graphical operation interface component and a background logic processing component; the graphical operation interface component is configured to determine a storage address of a data set in a preset storage area when receiving a content of the data set uploaded by a user, and display the content of the data set in a graphical interface, wherein the data set is applied for model training. The graphical operation interface component is also configured to submit a data annotation operation request to the background logic processing component while receiving a data annotation operation performed by the user on the content of the data set on the graphical interface. The background logic processing component is configured to obtain data annotation information according to the data annotation operation request, and store to the preset storage area corresponding to the storage address. The background logic processing component is also configured to perform model training based on the data set and the data annotation information, to generate a training model and a deep learning result evaluation report; and to store the training model and the deep learning result evaluation report in the preset storage area.

In addition, a deep learning guide method is provided by the present application. The method includes following steps: determining a storage address of a data set in a preset storage area when receiving a content of the data set uploaded by a user; displaying the content of the data set in a graphical interface, wherein the data set is applied for model training; obtaining data annotation information according to a data annotation operation when receiving the data annotation operation on the content of the data set performed by a user on the content of the data set on the graphical interface; storing the data annotation information to the preset storage area corresponding to the storage address; performing model training based on the data set and the data annotation information; generating a training model and a deep learning result evaluation report; and storing the training model and the deep learning result evaluation report in the preset storage area.

### Advantageous Effect

First, a storage address of a data set is determined in a preset storage area when a content of the data set uploaded by the user is received, the content of the data set is displayed in a graphical interface. Then, data annotation information on the content of the data set is obtained according to a data annotation operation request when a data annotation operation performed by a user is received on the graphical interface; the data annotation information is stored to the preset storage area corresponding to the storage address. Besides, a model training is performed based on the data set and the data annotation information; a training model and a deep learning result evaluation report are generated and stored lastly in the preset storage area. The deep learning guide device of the present disclosure can enable beginners in the field of deep learning and ordinary business personnel who only understand the needs while there is data but do not have deep learning related knowledge and experience to easily and quickly realize application requirements and to develop their own business based on artificial intelligence.

### BRIEF DESCRIPTION OF THE DRAWINGS

Above and/or additional aspects and advantages of the present application will be apparent and readily appreciated from the following description of embodiments with reference to the accompanying drawings, in which:

FIG. 1 is a structural block diagram of a deep learning guide device provided in an embodiment of the present disclosure.

FIG. 2 is a structural block diagram of a deep learning guide device provided in another embodiment of the present disclosure.

FIG. 3 is a schematic flowchart of a first embodiment of a deep learning guide method of the present disclosure.

FIG. 4 is another schematic flowchart of the first embodiment of the deep learning guide method of the present disclosure.

FIG. 5 is a schematic flowchart of a second embodiment of the deep learning guide method of the present disclosure.

FIG. 6 is a prototype diagram of a deep learning project creation interface provided in an embodiment of the present disclosure.

FIG. 7 is prototype diagram of a data annotation interface provided in an embodiment of the present disclosure.

FIG. 8 is a prototype diagram of a model training interface provided in an embodiment of the present disclosure.

FIG. 9 is a prototype diagram of a Model Deployment and Usage interface provided in an embodiment of the present disclosure.

FIG. 10 is a schematic block diagram of a structure of an electronic device provided in an embodiment of the present disclosure.

### DETAILED DESCRIPTION OF ILLUSTRATED EMBODIMENTS

It should be understand, the embodiments described herein are intended to illustrate the present disclosure and cannot be intended as a limitation to the present application.

The solutions of embodiments of the present disclosure are mainly: firstly, determining a storage address of a data set in a preset storage area when receiving a content of the data set uploaded by a user; displaying the content of the data set in a graphical interface, wherein the data set is applied for model training; obtaining data annotation information according to a data annotation operation when receiving the data annotation operation on the content of the data set performed by a user on the content of the data set on the graphical interface; storing the data annotation information to the preset storage area corresponding to the storage address; further, performing model training based on the data set and the data annotation information; generating a training model and a deep learning result evaluation report; lastly, storing the training model and the deep learning result evaluation report in the preset storage area. The deep learning guide device of the present disclosure can enable beginners in the field of deep learning and ordinary business personnel who only understand the needs while there is data but do not have deep learning related knowledge and experience to easily and quickly implement application requirements and develop their own business based on artificial intelligence.

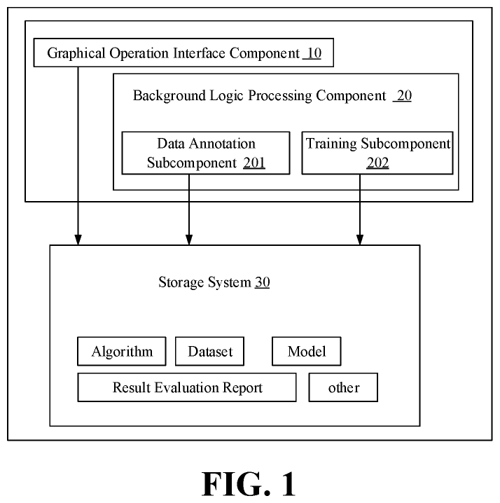

Referring to FIG. 1, FIG. 1 is a structural block diagram of a deep learning guide device provided by an embodiment of the present disclosure. In the embodiment, the deep learning guide device includes a graphical operation interface component 10, a background logic processing component 20, and a preset storage area 30.

The graphical operation interface component 10 interacts with the preset storage area 30 to implement functions such as data set selection (corresponding to a step S10 of a following deep learning guide method). The graphical operation interface component 10 is mainly configured to determine a storage address of a data set in a preset storage area when receiving a content of the data set uploaded by a user, wherein the data set is applied for model training.

It should be noted that, the preset storage area can be a computer storage system, and the storage system can be any storage medium that can be applied by the system.

In a specific implementation, the graphical operation interface component obtains basic information of the deep learning project filled by a user in a “Deep Learning Project Creation” interface. For example, in the embodiment, the user is required to fill the basic information such as project display name, project description, and so on in the “Deep Learning Project Creation” interface.

In a specific implementation, the graphical operation interface component obtains storage address information of the data set filled by the user in the “Deep Learning Project Creation” interface that has been uploaded to the storage system in advance and will be applied for model training.

The embodiment takes an object storage service system as the storage system (the preset storage area) as an example. The data set to be applied for deep learning model training can be uploaded to the object storage service system in advance by a client tool of the object storage service system.

For example, in the embodiment, a flower image dataset named flowers has been uploaded to a dataset directory of the user-omaiuser bucket in the object storage service in advance. The dataset comprises several flower picture files of various types and several file directories. The flower picture files of each flower type are stored in a first-level subdirectory with a same name (for example, the flower picture files of the rose type are all stored in the rose subdirectory under the root directory of the dataset), and a name of the root directory of the data set is flowers, then a storage address of the data set that the user needs to fill in the “Deep Learning Project Creation” interface is s3://user-omaiuser/dataset/flowers.

The graphical operation interface responds to a creation instruction of the user (namely a data annotation operation), assembles content of the data set into data annotation creation information, and submits the data annotation creation information and the storage address to the background logic processing component.

It should be understand, after the above steps are completed, the user can click the “Create” button, and the graphical operation interface component can submit the data annotation creation information to the background logic processing component. At this time, the user can wait for a result of the data set automatically annotated by a data annotation subcomponent in the “Data Annotation” interface of the graphical operation interface component.

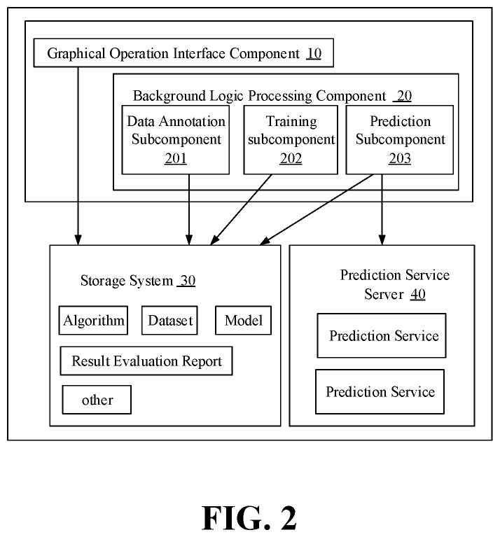

The graphical operation interface component 10 also interacts with the background logic processing component 20. The background logic processing component 20 is mainly configured to obtain data annotation information according to a data annotation operation request, and store it to the preset storage area corresponding to the storage address (corresponding to a step S20 of the following deep learning guide method); wherein, referring to FIG. 2, the background logic processing component 20 further includes a data annotation subcomponent 201. The data annotation subcomponent 201 interacts with the storage system to implement a data annotation function.

Specifically, when the background logic processing component receives the data annotation operation request and the storage address of the data set, the data annotation subcomponent is called. The data annotation subcomponent obtains the data annotation information according to the data annotation operation request, performs data annotation on the content of the data set, feeds back the data annotation information to the graphical operation interface component, and stores the data annotation information to the preset storage area corresponding to the storage address.

The background logic processing component 20 is also configured to perform model training based on the data set and the data annotation information, to generate a training model and a deep learning result evaluation report; to store the training model and the deep learning result evaluation report in the preset storage area (corresponding to a step S30 of the following deep learning guide method).

Specifically, the background logic processing component 20 further includes a training subcomponent 202 to implement the model training function.

The graphical operation interface component 10 obtains deep learning scene information and training mode information selected by the user based on the graphical operation interface; and obtains training job basic information input by the user based on the graphical operation interface, and assembles training job creation information according to the deep learning scene information, the training mode information, and the training job basic information.

The training subcomponent 202 is configured to create a model training job according to the training job creation information, and perform the model training job to generate a training model and a deep learning result evaluation report; and then store the generated training model and the generated result evaluation report to the store system and return the result evaluation report.

The deep learning guide device of the embodiment is applicable to beginners in the field of deep learning, and ordinary business personnel who only understand the needs while there is data but do not have deep learning related knowledge and experience. By organizing classic requirements into general services, using graphical interfaces to guide user operations, and presenting results graphically, only uploading data and annotating the data, common deep learning tasks can be completed automatically, which making beginners in the deep learning field, as well as ordinary business personnel who only understand the needs while there is data but do not have the relevant knowledge and experience of deep learning, can also easily and quickly implement application requirements.

Further, in another embodiment of the deep learning guide device of the present disclosure, the background logic processing component 20 further includes an inference subcomponent 203. The inference subcomponent 203 interacts respectively with the storage system 30 (namely the preset storage area) and the inference service server 40, the inference subcomponent 203 is mainly configured to implement an online inference service deployment function.

Specifically, if the background logic processing component 20 receives deployment operation creation information, the inference subcomponent 203 is called to complete a creation of a deployment operation. At this time, the inference subcomponent 203 can obtain the training model and other data in the storage system according to creation information, and then apply the data to create the deployment operation and perform it. The deployment operation can deploy an online inference service in an inference service server, and then return a generated network request address of the online inference service.

The inference subcomponent 203 interacts with the inference service server 40, and is mainly configured to implement an online inference service request processing function.

If the background logic processing component 20 receives inference request information, the inference subcomponent 203 is called to complete an inference request processing. At this time, the inference subcomponent 203 can call an inference service in the inference service server 40 based on the request information to complete the inference, and return an inference result.

The online inference service request processing function of the embodiment can facilitate the user to use the online inference service simply and quickly, and conveniently and intuitively view the inference result. By using the graphical interface to guide the user's operations, and by using a graphical or textual means to present the inference result, it only need to select the online inference service and fill in inference request data to use the online inference service, which makes ordinary users without deep learning related knowledge and without computer professional backgrounds can also use the online inference service to complete business processing conveniently and quickly.

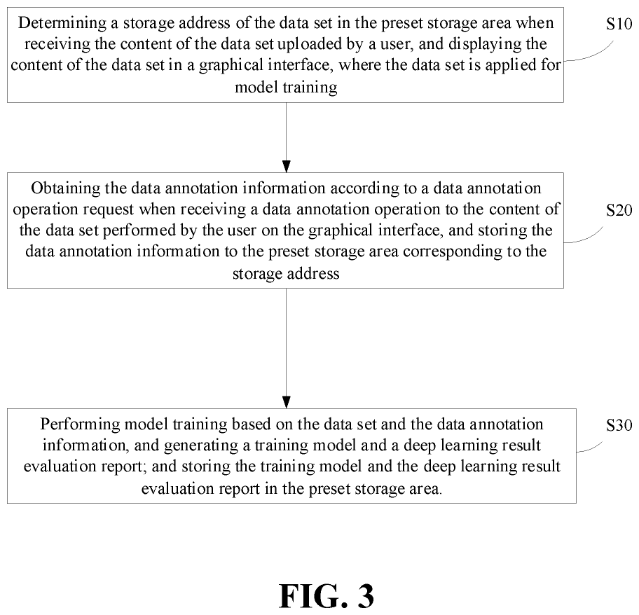

Additionally, in order to achieve the above mentioned purpose of the invention, a deep learning guide method is further proposed. Referring to FIG. 3, FIG. 3 is a schematic flowchart of a first embodiment of the deep learning guide method of the embodiment. The deep learning guide method includes:

Step S10: determining a storage address of the data set in the preset storage area when receiving the content of the data set uploaded by a user, and displaying the content of the data set in a graphical interface, where the data set is applied for model training.

It should be noted that the implementation subject of the embodiment is the above mentioned deep learning guide device itself, actions of all steps are completed by the above mentioned deep learning guide device; wherein, the preset storage area can be a computer storage system, and the storage system can be any storage medium that can be applied by the system.

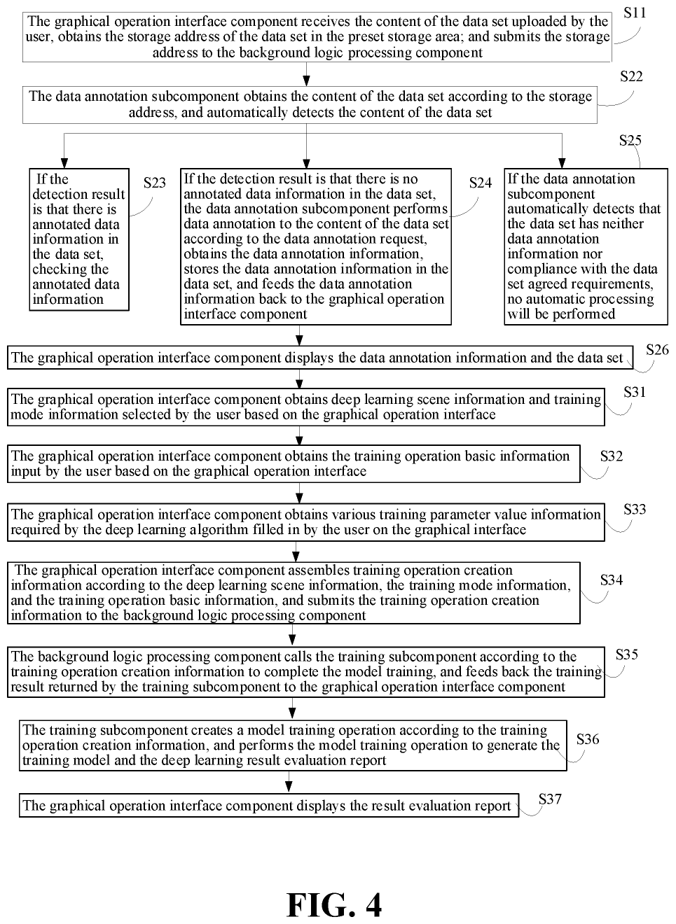

Specifically, referring to FIG. 4, the step S10 preferably further includes the following sub-steps:

Sub-step S11: the graphical operation interface component receives the content of the data set uploaded by the user, obtains the storage address of the data set in the preset storage area; and submits the storage address to the background logic processing component.

In a specific implementation, the graphical operation interface component obtains basic information of the deep learning project filled by the user in the “deep learning project creation” interface; for example, in the embodiment, the user is required to fill the project display name, project description and other basic information in the “Deep Learning Project Creation” interface.

The graphical operation interface component obtains the storage address information of the data set filled by the user in the “Deep Learning Project Creation” interface that has been uploaded to the storage system in advance and will be applied for model training.

The embodiment takes an object storage service system as the storage system (preset storage area) as an example. The data set applied for the deep learning model training can be uploaded to the object storage service system in advance by using the client tool of the object storage service system.

For example, in the embodiment, a flower image dataset named flowers has been uploaded to the dataset directory of the user-omaiuser bucket in the object storage service in advance. The dataset consists of several flower picture files of various types and several file directories. The flower picture files of each flower type are stored in the first-level subdirectory with a same name (for example, the flower picture files of the rose type are all stored in the rose subdirectory under the root directory of the dataset), and the name of the root directory of the data set is flowers, then the storage address of the data set that the user needs to fill in the “deep learning project creation” interface is s3://user-omaiuser/dataset/flowers.

Step S20: obtaining the data annotation information according to a data annotation operation request when receiving a data annotation operation to the content of the data set performed by the user on the graphical interface, and storing the data annotation information to the preset storage area corresponding to the storage address.

Specifically, when the graphical operation interface component receives the data annotation operation to the content of the data set performed by the user on the graphical interface, submits a data annotation operation request to the background logic processing component.

When the background logic processing component receives the data annotation operation request and the storage address of the data set, the data annotation subcomponent is called to perform step S21: the data annotation subcomponent obtains data annotation information according to the data annotation operation request, and feeds back the data annotation information returned by the data annotation subcomponent to the graphical operation interface component.

Correspondingly, referring to FIG. 4, the step S21 preferably includes the following sub-steps:

Sub-step S22: the data annotation subcomponent obtains the content of the data set according to the storage address, and automatically detects the content of the data set.

Specifically, for example, the data annotation subcomponent in the embodiment can obtain the data set named flowers under the dataset directory of the user-omaiuser bucket in the object storage service according to the storage address s3://user-omaiuser/dataset/flowers, identify and determine the files and directories in the root directory of the data set.

Sub-step S23: if the detection result is that there is annotated data information in the data set, checking the annotated data information.

It should be noted that, the storage structure and storage method of data annotation information can be flexible and changeable, and the present patent does not limit it.

In a specific implementation, the data annotation information in the embodiment is stored in a JSON text format in a file named annotations.json in the root directory of the data set. An example of the information is shown below, where the “labels” field stores label names, each label represents a kind of flowers, and the “annotations” field stores the mapping relationships between the flower picture files and the labels. Then the data annotation subcomponent can first determine whether there is a file named annotations.json in the root directory of the data set, and if there is, it can checks the data annotation information in the file, for example, check whether it exists in the data set that the image files in all the mapping relationships, if it does not exist, delete the mapping relationship to ensure that the annotation information is correct.

{
“labels”: [“sunflower”, “rose”],
“annotations”: [{
“file_path”:
“s3://user-omaiuser/dataset/flowers/sunflower/image-01.jpg”,
“labels”: [“sunflower”]
}, {
“file_path”:
“s3:/user-omaiuser/dataset/flowers/sunflower/image-02.jpg”,
“labels”: [“sunflower”]
}, {
}, {
“file_path”:
“s3:/user-omaiuser/dataset/flowers/rose/image-03.jpg”,
“labels”: [“rose”]
“file_path”:
“s3:/user-omaiuser/dataset/flowers/rose/image-04.jpg”,
“labels”: [“rose”]
}, {
“file_path”:
“s3:/user-omaiuser/dataset/flowers/rose/image-05.jpg”,
“labels”: [“rose”]
}]
}

Sub-step S24: if the detection result is that there is no annotated data information in the data set, the data annotation subcomponent performs data annotation to the content of the data set according to the data annotation request, obtains the data annotation information, stores the data annotation information in the data set, and feeds the data annotation information back to the graphical operation interface component.

It should be understand, that if the data annotation subcomponent automatically detects that there is no data annotation information in the data set, but follows the data set convention rule, it can automatically perform data annotation to the data set and store the data annotation information; the data set convention rule refer to the conditions and requirements that the data set proposed by this method should comply with, so that the data set can be automatically detected by the data annotation subcomponent and data annotation can be performed automatically.

For example, the data set convention rule in the embodiment stipulate that only subdirectories but no files can be existed in the root directory of the data set, and the flower picture files of each flower type are stored in a same first-level sub-directory under the root directory of the data set, the name of the first-level sub-directory under the root directory is the label name in the annotation information, and all flower picture files in the first-level sub-directory belong to a category represented by the label name corresponding to the first-level subdirectory (for example, all flower picture files in the first-level subdirectory named rose belong to pictures of roses). Since the flower picture data set named flowers applied in the embodiment meets the requirements of the data set convention rule, the data annotation subcomponent can automatically construct the label name in the annotation information according to the name of the first-level subdirectory, and construct a mapping relationship in the annotation information according to the flower picture files in the subdirectory of the first level, and store the annotation information in the annotations.json file under the root directory of the dataset.

Sub-step S25: if the data annotation subcomponent automatically detects that the data set has neither data annotation information nor compliance with the data set convention rule, no automatic processing will be performed.

Sub-step S26: the graphical operation interface component displays the data annotation information and the data set.

In addition, after the sub-step S26, the method further includes:

Sub-step: the background logic processing component obtains secondary manual data annotation information input by the user based on a graphical operation interface, the graphical operation interface corresponds to the graphical operation interface component. The background logic processing component calls the data annotation subcomponent to store the secondary manual data annotation information to the data set; and feeds back the secondary manual data annotation information to the graphical operation interface component.

It should be understand, that the data annotation subcomponent automatically performs data annotation on the data set, and a result of which may not meet all expectations of the user. Further, the data set uploaded by the user may not meet all of the data set convention rule proposed by the present disclosure. Therefore, the user can further manually annotate the data set in the graphical operation interface component.

For example, in the embodiment, the data annotation subcomponent automatically performs data annotation on the data set, and the result of which is that each flower image file has only one annotation information. But in fact, it is possible there are many different types of flowers in one flower picture file, the user can manually add multiple annotation information to these pictures in the “Data Annotation” interface.

Sub-step: the graphical operation interface component displays the data annotation information (including the secondary manual data annotation information) and the data set.

For example, in the embodiment, the graphical operation interface component can display all label names of the data annotation file in the “Data Annotation” interface, and also display all the flower picture files of the data set, and a list of label names corresponding to each flower picture file.

Step S30: performing model training based on the data set and the data annotation information, and generating a training model and a deep learning result evaluation report; and storing the training model and the deep learning result evaluation report in the preset storage area.

Specifically, referring to FIG. 4, the step S30 embodiment further includes the following sub-steps:

Sub-step S31: the graphical operation interface component obtains deep learning scene information and training mode information selected by the user based on the graphical operation interface.

It should be understand, that the embodiment provides a variety of deep learning scenes (such as an image classification scene, a data inference scene, and an image semantic segmentation scene), and supports a full training mode and an incremental training mode. If the full training mode is specified, the deep learning algorithm can apply the data set and the annotation information thereof to retrain while training a model; if the incremental training mode is specified, when the deep learning algorithm trains the model, it can first obtain and analyze a specified basic training model, and then to retrain analyzed model features and data set and the annotation information thereof to continue training.

For example, in the embodiment, the image classification scene is applied, and the incremental training mode is applied, and the user needs to select an “Image Classify Scene” option in the drop-down selection box of the “Deep Learning Scene” on the “Data Annotation” interface of the graphical operation interface component, check the “Incremental Training Mode” radio box, and select the basic training model in the “Basic Model” drop-down selection box that is applied for the incremental training.

Sub-step S32: the graphical operation interface component obtains the training job basic information input by the user based on the graphical operation interface.

For example, in the embodiment, the user is required to fill in the display name of the training job, select the storage address of the generated training model in the object storage service, and select the resource pool and resource specification required for an implementation of the training job, and other information on the “Data Annotation” interface of the graphical operation interface component.

Sub-step S33: the graphical operation interface component obtains various training parameter value information required by the deep learning algorithm filled in by the user on the graphical interface. This step is an optional operation.

It should be understand, that the embodiment has a default implementation processing for an implementation of the underlying algorithm, an algorithm selection and other details of the deep learning. Therefore, the present disclosure is not only suitable for professional users, but also suitable for non-professional users. In order to enable an effect of model training to be controlled more accurately, the present disclosure supports the user to specify various training parameter values required by the model training algorithm in the graphical operation interface component. However, this step is an optional step.

For example, in the embodiment, the user can specify the maximum running time (such as 200 minutes) for the training job on the “Data Annotation” interface of the graphical operation interface component. Then when the deep learning algorithm performs the model training, if an implementation time is up to the maximum time the performance is still not completed, the deep learning algorithm will automatically store the training results and end the training. The user can also specify a minimum accuracy of the generated training model (such as 0.98), then when the deep learning algorithm performs the model training, within the maximum running time, if the minimum accuracy of the generated training model does not reach the specified value, a tuning training will continue, otherwise the result will be stored and the training will end.

Sub-step S34: the graphical operation interface component assembles training job creation information according to the deep learning scene information, the training mode information, and the training job basic information, and submits the training job creation information to the background logic processing component.

It should be understand, that after the above steps are completed, the user can click the “Create” button, and the graphical operation interface component can submit the training job creation information to the background logic processing component. At this time, the user can view detail information of a created training job on the “Model Training” interface of the graphical operation interface component, and wait for the training job to be implemented to complete in the background logic processing component.

Sub-step S35: the background logic processing component calls the training subcomponent according to the training job creation information to complete the model training, and feeds back the training result returned by the training subcomponent to the graphical operation interface component.

It should be understand, that after the background logic processing component receives the training job creation information, it can call the training subcomponent to create the training job and submit the training job creation information to the training subcomponent. When the training subcomponent completes the model training, a result returned by the training subcomponent is returned to the graphical operation interface component for displaying.

Sub-step S36: the training subcomponent creates a model training job according to the training job creation information, and performs the model training job to generate the training model and the deep learning result evaluation report.

It should be understand, that while performing the training job, the training subcomponent can obtain a corresponding deep learning algorithm from the object storage system according to the deep learning scene information in the creation information, and obtain the data set from the object storage system according to the data set information, and obtain a basic training model from the object storage system according to the incremental training information, and then use the deep learning algorithm, the data set, the annotation information thereof, and the basic training model to perform incremental model training. While the training is successful, the training job will store the generated training model and result evaluation report to the corresponding location according to model storage address information in the creation information.

Step S37: the graphical operation interface component displays the result evaluation report.

The graphical operation interface component can display an implementation status of the training job in real time, when the implementation of the training job is completed and successful, the result evaluation report can be displayed in the graphical operation interface component. However, whether to display or not depends on the user, so this step is an optional step.

For example, in the embodiment, if the result evaluation report is selected to be displayed, in an operation column of the training job list on the “Model Training” interface, the “Model Evaluation” button is clicked to view the result evaluation report presented in a chart form. From the result evaluation report, it can be viewed the implementation information of the training job and some evaluation information of the training model, such as the implementation time of the training job, accuracy, precision, recall, and F1 value of the training model.

The embodiment can enable the beginners in the field of the deep learning, and the ordinary business personnel who only understand the needs while there is data but do not have the relevant knowledge and experience of the deep learning to easily and quickly implement application requirements and develop themselves business based on the artificial intelligence. By adopting the above mentioned technical solution of the embodiment, it enables a concealment of complex and professional of the technical knowledge, automatic algorithm selection and algorithm realization to realize, so as to lower the difficulty and complexity of use of the deep learning technology.

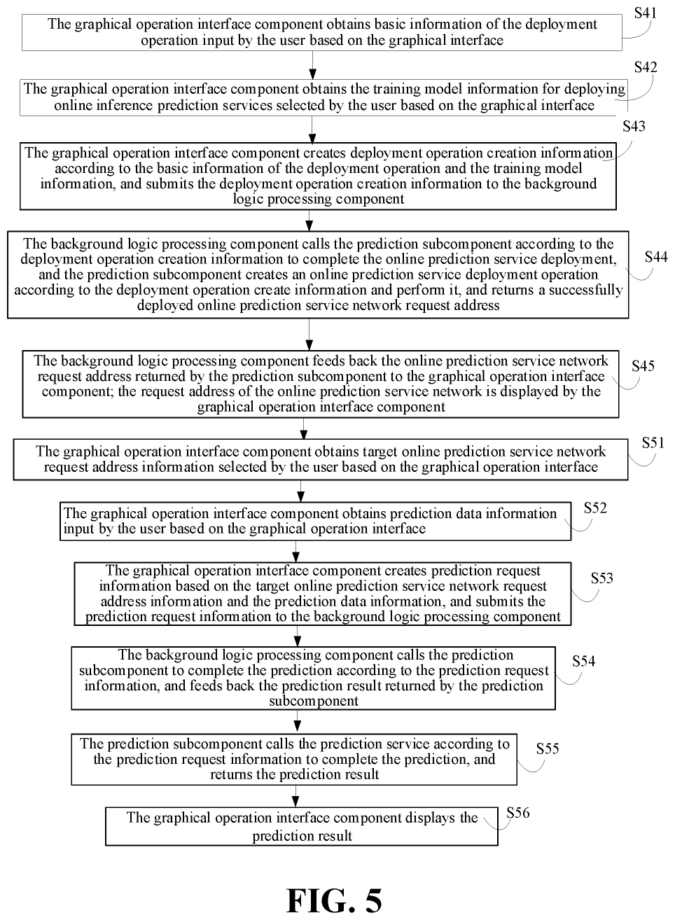

Further, referring to FIG. 5, based on the first embodiment of the above mentioned deep learning guide method, a second embodiment of the deep learning guide method is also proposed. In this embodiment, after the step S30, the deep learning guide method further includes:

Implement the online inference service deployment function. When the background logic processing component receives deployment operation creation information, it can call the inference subcomponent to complete a creation of the deployment operation. At this time, the inference subcomponent can obtain the training model and other data from the storage system according to the creation information, and then use the data to create the deployment operation and perform it. The deployment operation can deploy an online inference service in an inference service server, and then return a network request address for the generated online inference service. In a specific implementation, sub-step S41 to sub-step S45 are included.

Sub-step S41: the graphical operation interface component obtains basic information of the deployment operation input by the user based on the graphical interface.

For example, in the embodiment, the user is required to fill in the display name of the deployment operation, to select resource pool, resource specifications, and other information required for implementing of the deployment operation on the “Model Training” interface of the graphical operation interface component.

Sub-step S42: the graphical operation interface component obtains training model information for deploying online inference services selected by the user based on the graphical interface.

It should be understand, that the deployment operation uses the training model to deploy the online inference service. Therefore, before creating the deployment operation, the user needs to specify a basic model for deploying the online inference service.

For example, in the embodiment, the user is required to select a successfully trained training model in the “Deployment Model” drop-down selection box of the “Model Training” interface in the graphical operation interface component.

Sub-step S43: the graphical operation interface component creates deployment operation creation information according to the basic information of the deployment operation and the training model information, and submits the deployment operation creation information to the background logic processing component.

After the above steps are completed, the user can click the “Create” button, and the graphical operation interface component will submit the deployment operation creation information to the background logic processing component. At this time, the user can view detailed information of the created deployment operation on a “Model Deployment and Usage” interface of the graphical operation interface component, and wait for the deployment operation to be completed in the background logic processing component.

Sub-step S44: the background logic processing component calls the inference subcomponent according to the deployment operation creation information to complete the online inference service deployment, and the inference subcomponent creates an online inference service deployment operation according to the deployment operation create information and perform it, and returns a successfully deployed online inference service network request address.

After the background logic processing component receives the deployment operation creation information, it can call the inference subcomponent to create the inference operation, and transfer the creation information to the inference subcomponent, and waits for the inference subcomponent to complete the online inference service deployment, and a result returned by the inference subcomponent is returned to the graphical operation interface component for displaying.

When the deployment operation is performed, the inference subcomponent can obtain a corresponding training model in the object storage system according to the training model information in the created information, and then use the training model to deploy the online inference service. After the deployment is successful, the network request address of the online inference service is returned.

Sub-step S45: the background logic processing component feeds back the online inference service network request address returned by the inference subcomponent to the graphical operation interface component; the request address of the online inference service network is displayed by the graphical operation interface component.

It should be understand, that the above steps (S41-S45) use the generated training model to deploy the online inference service and expose the network request address of the online inference service, these are optional steps. If only need to use the training model of the embodiment, do not need to deploy the online inference service, these steps are not required. Therefore, the content of these steps does not limit the present disclosure.

The online inference service request processing functions in the embodiment can facilitate the user to use the online inference service simply and quickly, and to view the inference result conveniently and intuitively. By using the graphical interface to guide the user's operations and using the graphical or textual means to present the inference results, it only need to select the online inference service and fill in the inference request data to use the online inference service, which allows ordinary users without deep learning related knowledge and no computer professional backgrounds to use online inference services to complete business processing conveniently and quickly.

Further, after the online inference service deployment function (sub-step S41 to sub-step S45), it also includes an implementation of the online inference service request processing function (it should be noted that if the online inference service is not deployed, accordingly there is no need to process an inference service request).

If the background logic processing component receives the inference request information, it can call the inference subcomponent to complete the inference request processing. At this time, the inference subcomponent can call an inference service in the inference service server according to requested information to complete an inference, and return the inference result. In a specific implementation, it includes sub-step S51 to sub-step S56.

Sub-step S51: the graphical operation interface component obtains target online inference service network request address information selected by the user based on the graphical operation interface.

For example, in the embodiment, the user can click the “Use Now” button in the operation column of the online inference service listed in the “Model Deploy and Use” interface to select the network request address of the online inference service, at this time all the inference request operations made in a inference service use interface will be initiated for the network request address.

Sub-step S52: the graphical operation interface component obtains inference data information input by the user based on the graphical operation interface.

For example, in the embodiment, the user can click the “Select Picture” button in the inference service use interface of the “Model Deployment and Usage” interface, and select a local rose flower picture file in an opened file selection pop-up box, and click “OK” button in the pop-up box.

Sub-step S53: the graphical operation interface component creates inference request information based on the target online inference service network request address information and the inference data information, and submits the inference request information to the background logic processing component.

After the above steps are completed, the user can click the “Inference” button, the graphical operation interface component can submit inference request data information to the background logic processing component. At this time, the user can wait to view the inference results on the “Model Deployment and Usage” interface of the graphical operation interface component.

Sub-step S54: the background logic processing component calls the inference subcomponent to complete the inference according to the inference request information, and feeds back the inference result returned by the inference subcomponent.

After the background logic processing component receives the inference request data information, it can call the inference subcomponent to perform the inference, and transfer the requested data information to the inference subcomponent, and wait for the inference subcomponent to complete the inference. At the time, it returns the inference result returned by the inference subcomponent to the graphical operation interface component for displaying.

Sub-step S55: the inference subcomponent calls the inference service according to the inference request information to complete the inference, and returns the inference result.

The inference subcomponent component can find a corresponding inference service according to the inference service network request address in the requested data information (the inference subcomponent interacts with the inference service server, and the inference service is stored in the inference service server), and then call the inference service to perform inference on requested data. After the inference is successfully performed, an inference result is returned.

Sub-step S56: the graphical operation interface component displays the inference result.

In the embodiment, the graphical operation interface component can display the inference result in a chart format, or display the inference result in a JSON format.

For example, in the embodiment, the inference result is displayed in the JSON format as an example. After the inference is completed, the user can click the “JSON Format” button on the “Model Deployment and Usage” interface of the graphical operation interface component, the inference result can be displayed in the JSON format. An example of the result is shown below. The second line indicates that when the image file is predicted, the maximum probability is a rose flower image file, and the third line indicates an accuracy rate of the picture file being a rose flower picture file is 0.9862; the lines 4th to 10th indicate the possibility and accuracy rate that the picture may be a picture file of a certain flower type.

{
“predict_label”: “rose”,
“prob”: 0.9862,
“total_info”: [{
“label”: “rose”,
“prob”: 0.9862
}, {
“label”: “sunflower”,
“prob”: 0.0138
}]
}

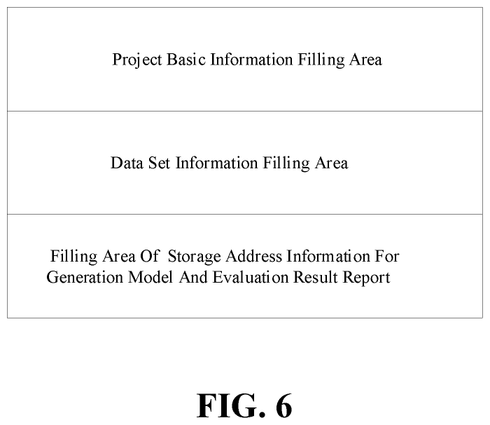

Further, for illustration, referring to FIGS. 6 to 9, which show interface prototype diagrams of the graphical operation interface component provided by the embodiments of the present disclosure.

As shown in FIG. 6, it is a “Deep Learning Project Creation” interface prototype diagram of the graphical operation interface component. The interface is mainly configured for creating of the deep learning projects. The interface mainly includes: a filling area of the project basic information, a filling area of the data set information, and a filling area of the storage address information for generation model and evaluation result report.

It should be understand, that a deep learning project refers to a general term for all operations in a certain deep learning scene performed on the same data set. A deep learning project can only use one data set, and the same data set can be performed multiple times data annotation, and the model training is performed separately based on the results of each data annotation, and the model deployment is performed separately based on each generated training model.

For example, the user fills in relevant information in the interface and clicks the “Create” button to create a deep learning project. If a creation is successful, it can automatically jump to the “Data Annotation” interface.

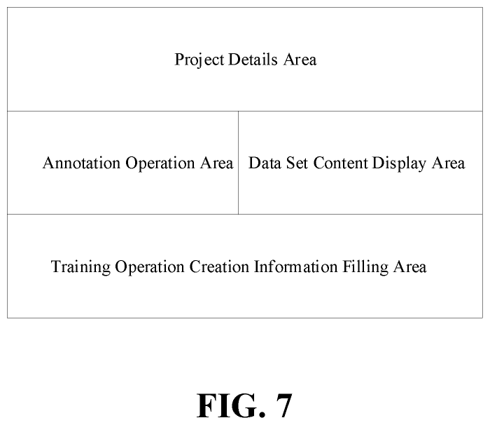

As shown in FIG. 7, which is a prototype diagram of a “Data Annotation” interface of the graphical operation interface component. The interface is mainly configured for data annotation and functional operations of the model training. The interface mainly includes: a project details area, an annotation operation area, a data set content display area, and a training job creation information filling area.

For example, after the user completes a data annotation operation in the interface, he can fill in relevant information in “Training Job Creation Information Filling Area” of the interface and click the “Create” button to create a model training job. If a creation is successful, it can automatically jump to the “Model Training” interface.

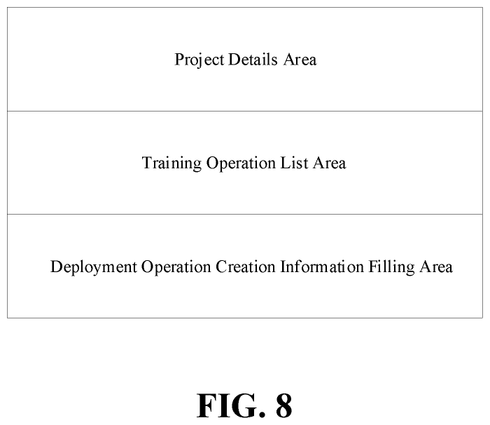

As shown in FIG. 8, it is a prototype diagram of the “Model Training” interface of the graphical operation interface component. The interface is mainly configured for model training and functional operations of model deployment. The interface mainly includes: a project details area, a training job list area, and a deployment operation creation information filling area.

For example, in the interface, the user can jump to the “Model Training” interface to recreate a model training job, also can fill in relevant information in the “Deployment Operation Creation Information Filling Area” of the interface and click the “Create” button to create a model deployment operation. If a creation is successful, it can automatically jump to a “Model Deployment and Usage” interface.

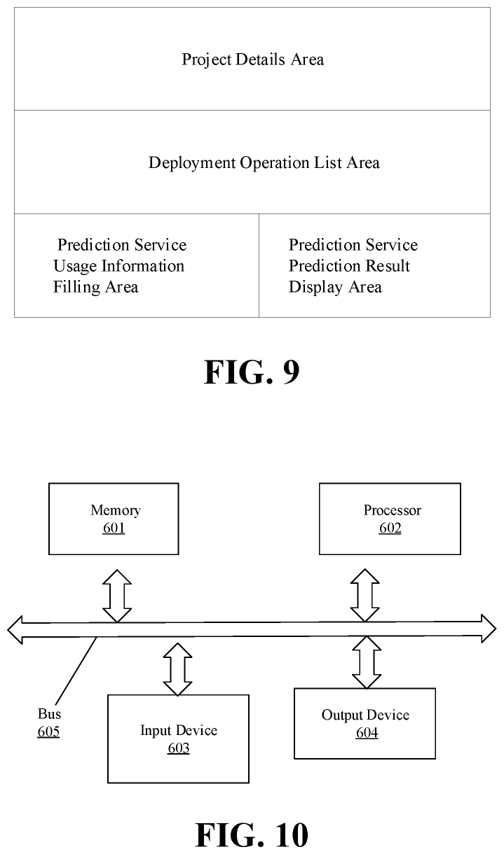

As shown in FIG. 9, it is a prototype diagram of the “Model Deployment and Usage” interface of the graphical operation interface component. The interface is mainly configured for model deployment and functional operations applied by the online inference services. The interface mainly includes: a project details area, a deployment operation list area, an inference service usage information filling area, and an inference service inference result display area.

For example, the user can jump to a “Model Training” interface in the interface to recreate a new model deployment interface, can also fill in relevant information in the “Inference service Usage Information Fill Area” of the interface and click the “Inference” button to use the online inference service. And the inference results returned by the online inference service will be displayed in real time in “Inference service Inference Results Display Area”.

An electronic device is provided by an embodiment of the present application. Please refer to FIG. 10. The electronic device includes a memory 601, a processor 602, and a computer program stored in the memory 601 and can be performed on the processor 602. The processor 602 performs the computer program to implement the deep learning guide methods described in the previous section.

Further, the electronic device includes at least one input device 603 and at least one output device 604.

The memory 601, the processor 602, the input device 603 and the output device 604 connect via a bus 605.

The input device 603 may specially be a camera, a touch panel, a physical button or a mouse, and so on. The output device 604 may specially be a display screen.

The memory 601 may be a high-speed random access memory (RAM) memory, or a non-volatile memory, such as a disk memory. The memory 601 is configured to store a group of executable program codes, and the processor 602 couples with the memory 601.

Further, a computer readable storage medium is provided by embodiments of the present application. The computer readable storage medium can be arranged in the electronic device in each of the forgoing embodiments, and the computer readable storage medium may be the above mentioned memory 601. A computer program is stored on the computer readable storage medium, and the program is performed by the processor 602 to implement the deep learning guide methods described in the forgoing embodiments.

Further, the computer readable storage medium may also be a U disk, a mobile hard disk, a read-only memory (ROM, Read-Only Memory 601, RAM, a magnetic disk, or an optical disk, and other media that can store program codes.

It should be noted that in this article, the terms “include”, “contain” or any other variants thereof are intended to cover non-exclusive inclusion, so that the process, the method, the article or device of including a series of elements includes not only those elements, but also other elements that are not explicitly listed, or elements inherent to the process, method, article, or device. If there are no more restrictions, the element defined by the sentence “including a . . . ” does not exclude the existence of other same elements in the process, the method, the article, or the device that includes the element.

The serial numbers of the embodiments of the above mentioned present disclosure are only for description, and do not represent the superiority or inferiority of the embodiments.

The above are only the preferred embodiments of the present disclosure, and do not limit the patent scope of the present disclosure. Any equivalent structure or equivalent process transformation made by using the content of the description and drawings of the present disclosure, or directly or indirectly applied in other related technical fields, the same is included in the scope of patent protection of the present disclosure.

What is claimed is:

1. A deep learning guide device, comprising
a memory,
a processor, and
a computer program which is stored in the memory and can be operated on the processor, wherein the processor implements following steps when executing the computer program:
determining a storage address of a data set in a preset storage area when receiving a content of the data set uploaded by a user, and displaying the content of the data set in a graphical interface, wherein the data set is applied for model training;
submitting a data annotation operation request when receiving a data annotation operation to the content of the data set performed by the user on the graphical interface;
obtaining data annotation information according to the data annotation operation request, and storing the data annotation information to the preset storage area corresponding to the storage address; and
performing the model training based on the data set and the data annotation information, generating a training model and a deep learning result evaluation report; and storing the training model and the deep learning result evaluation report in the preset storage area.

2. The deep learning guide device according to claim 1, wherein after obtaining the data annotation information according to the data annotation operation request, the processor further implements following steps:
displaying the data annotation information and the data set;
acquiring deep learning scene information and training mode information selected by the user based on a graphical operation interface; getting training operation basic information input by the user based on the graphical operation interface; and creating training operation creation information according to the deep learning scene information, the training mode information and the training operation basic information;
creating a model training operation according to the training operation creation information, and performing the model training operation to generate the training model and the deep learning result evaluation report.

3. The deep learning guide device according to claim 2, wherein the processor further implements following steps:
implementing an online prediction service deployment function and an online prediction service request processing function.

4. A deep learning guide method, comprising following steps:
determining a storage address in a preset storage area when receiving content of a data set uploaded by a user, and displaying the content of the data set in a graphical interface, where the data set is applied for model training;
receiving a data annotation operation to the content of the data set performed by the user on the graphical interface, obtaining data annotation information according to the data annotation operation, and storing the data annotation information to the preset storage area corresponding to the storage address;
performing the model training based on the data set and the data annotation information, generating a training model and a deep learning result evaluation report; and storing the training model and the deep learning result evaluation report to the preset storage area.

5. The deep learning guide method according to claim 4, wherein
the step of performing the model training based on the data set and the data annotation information, generating the training model and the deep learning result evaluation report, specifically comprises:
obtaining deep learning scene information and training mode information selected by the user based on a graphical operation interface;
obtaining training operation basic information input by the user based on the graphical operation interface;
assembling training operation creation information according to the deep learning scene information, the training mode information and the training operation basic information, and submitting the training operation creation information;
completing the model training according to the training operation creation information, and feeding back a training result; and
creating a model training operation according to the training operation creation information, and performing the model training operation to generate the training model and the deep learning result evaluation report.

6. The deep learning guide method according to claim 4, wherein
the step of determining the storage address in the preset storage area when receiving the content of the data set uploaded by the user, specifically comprises:
receiving the content of the data set uploaded by the user, and
obtaining the storage address of the data set in the preset storage area.

7. The deep learning guide method according to claim 4, wherein
the step of receiving the data annotation operation to the content of the data set performed by the user on the graphical interface, obtaining the data annotation information according to the data annotation operation, specifically comprises:
generating a data annotation operation request when receiving the data annotation operation to the content of the data set performed by the user on the graphical interface;
obtaining the data annotation information according to the data annotation operation request; and
storing the data annotation information to the preset storage area corresponding to the storage address.

8. The deep learning guide method according to claim 7, wherein
the step of obtaining the data annotation information according to the data annotation operation request specifically comprises:
obtaining the content of the data set according to the storage address, and automatically detecting the content of the data set;
when a detection result is that there is annotated data information in the data set, checking the annotated data information;
when the detection result is that there is no annotated data information in the data set, performing data annotation on the content of the data set according to the data annotation operation request, obtaining the data annotation information, and storing the data annotation information to the data set;
displaying the data annotation information and the data set.

9. The deep learning guide method according to claim 8, wherein
after the step of displaying the data annotation information and the data set, further comprises:
determining whether a result of the data annotation performed on the data set meets all expectations of the user, and determining whether the data set uploaded by the user all meets a data set agreed requirement;
when one of determined results is no, receiving manual annotation on the data set performed by the user.

10. The deep learning guide method according to claim 9, wherein
the step of receiving the manual annotation on the data set performed by the user, comprises
obtaining secondary manual data annotation information inputted by the user based on a graphical operation interface;
storing the secondary manual data annotation information to the data set, and feeding back the secondary manual data annotation information to the graphical operation interface.

11. The deep learning guide method according to claim 10, wherein
after the step of storing the training model and the deep learning result evaluation report to the preset storage area, the method further comprises following steps:
performing an online prediction service based on a deployment operation input by the user on the graphic operation interface, and displaying an online prediction service network request address; and
performing a prediction based on target online prediction service network request address information selected by the user on the graphical operation interface, and displaying a prediction result.

12. The deep learning guide method according to claim 11, wherein the step of performing the online prediction service based on the deployment operation input by the user on the graphic operation interface, and displaying the online prediction service network request address, comprises:
obtaining deployment operation basic information inputted by the user based on the graphical interface;
obtaining training model information for deploying the online prediction service selected by the user based on the graphical interface;
creating deployment operation creation information according to the deployment operation basic information and the training model information;
completing an online prediction service deployment according to the deployment operation creation information, creating an online prediction service deployment operation according to deployment operation create information and performing it, and returning a successfully deployed online prediction service network request address; and
feeding back the online prediction service network request address; and displaying the online prediction service network request address.

13. The deep learning guide method according to claim 12, wherein the step of performing the prediction based on the target online prediction service network request address information selected by the user on the graphical operation interface, and displaying the prediction result, comprises:
obtaining the target online prediction service network request address information selected by the user based on the graphical operation interface;
obtaining prediction data information input by the user based on the graphical operation interface;
creating prediction request information based on the target online prediction service network request address information and the prediction data information;
calling a prediction server to complete the prediction according to the prediction request information, and feeding back the prediction result; and
displaying the prediction result.

14. The deep learning guide method according to claim 13, wherein completing the prediction according to the prediction request information, and feeding back the prediction result, comprises:
performing the prediction after receiving the prediction request data information;
transferring requested data information to complete the prediction; and
returning the prediction result for displaying when the prediction is completed.

15. The deep learning guide method according to claim 13, wherein the step of calling the prediction server to complete the prediction according to the prediction request information and feeding back the prediction result, comprises:
finding a corresponding prediction service according to the prediction service network request address in requested data information;
calling the prediction server to performing the prediction on the requested data; and
returning the prediction result after the prediction is successful.

16. The deep learning guide method according to claim 13, wherein displaying the prediction result comprises:
displaying the prediction result in a chart format, or
displaying the prediction result in a JSON format.

17. An electronic device, comprising a storage memory, a processor, and a computer program stored in the memory, wherein the processor performs the computer program to implement the deep learning guide method according to claim 4.

18. A computer-readable storage medium, storing a computer program, wherein the computer program is performed by a processor to implement the deep learning guide method according to claim 4.
